(19) United States
(12) Patent Application Publication
(10) Pub. No.: US 2026/0158388 A1
(43) Pub. Date: Jun. 11, 2026

(54) INTERACTION PROCESSING

(71) Applicant: TENCENT TECHNOLOGY (SHENZHEN) COMPANY LIMITED, Shenzhen (CN)

(72) Inventors: Tao WANG, Shenzhen (CN); Lei ZHENG, Shenzhen (CN); Sen LIN, Shenzhen (CN)

(73) Assignee: TENCENT TECHNOLOGY (SHENZHEN) COMPANY LIMITED, Shenzhen (CN)

(21) Appl. No.: 19/181,222

(22) Filed: Apr. 16, 2025

Related U.S. Application Data
(63) Continuation of application No. PCT/CN2023/130195, filed on Nov. 7, 2023.

(30) Foreign Application Priority Data
Jan. 6, 2023 (CN) 202310021235.8

(51) Int. Cl. A63F 13/56; A63F 13/2145; A63F 13/533; A63F 13/812; G06F 3/0486; G06F 3/0488

(52) U.S. Cl. CPC A63F 13/56; A63F 13/2145; A63F 13/533; A63F 13/812; G06F 3/0486; G06F 3/0488

(57) ABSTRACT

In a method for interaction processing, a virtual scene that includes a first virtual object and a plurality of second virtual objects is displayed in a game interaction interface. Visual identifiers that each follow a respective second virtual object of the plurality of second virtual objects and, in a region adjacent to the first control element, a plurality of manipulation control elements that each indicate a respective visual identifier of the visual identifiers are displayed based on selection of a first control element associated with an interaction operation. The first virtual object is controlled, based on a selection of a particular manipulation control element of the plurality of manipulation control elements, to perform the interaction operation with a target virtual object that corresponds to a particular second virtual object that is followed by the respective visual identifier indicated by the selected particular manipulation control element.

### RELATED APPLICATIONS

The present application is a continuation of International Application No. PCT/CN 2023/130195, filed on Nov. 7, 2023, which claims priority to Chinese Patent Application No. 202310021235.8, filed on Jan. 6, 2023. The entire disclosures of the prior applications are hereby incorporated by reference.

### FIELD OF THE TECHNOLOGY

This disclosure relates to the field of human-computer interaction technologies including an interaction processing method and apparatus for a virtual scene, an electronic device, and a computer storage medium.

### BACKGROUND OF THE DISCLOSURE

The human-computer interaction technology for a virtual scene based on graphics processing hardware can achieve diversified interaction between virtual objects controlled by a user or artificial intelligence according to an actual application requirement, which has a wide range of practical use. For example, in a virtual scene such as a game, a real battle process between virtual objects can be simulated.

A sports game (such as a basketball game) is used as an example. In a solution provided in the related art, when ball passing is designated, ball passing relies on an operation by a player. For example, when the player presses a ball passing button to slide, there is a connection line between a ball passing virtual object and a ball receiving virtual object, and the player may perform a sliding operation to select a ball receiving object.

However, the player needs to slide to a direction of a specific player on which the player is intended to perform ball passing. This has a high requirement on an operation by the player. In addition, positioning is not very accurate. Consequently, it is very difficult for the player to precisely find an object on which the player is intended to perform ball passing in high-tempo game experience. In addition, during use of a ball passing function, if basketballers are close to each other, it is very difficult for the player to perform an operation.

### SUMMARY

Embodiments of this disclosure include a method and an apparatus for interaction processing, an electronic device, a non-transitory computer-readable storage medium, and a computer program product.

Technical solutions of embodiments of this disclosure may be implemented as follows.

An embodiment of this disclosure provides a method for interaction processing. In the method, a virtual scene that includes a first virtual object and a plurality of second virtual objects is displayed in a game interaction interface. Visual identifiers that each follow a respective second virtual object of the plurality of second virtual objects and, in a region adjacent to the first control element, a plurality of manipulation control elements that each indicate a respective visual identifier of the visual identifiers are displayed based on selection of a first control element associated with an interaction operation. The first virtual object is controlled, based on a selection of a particular manipulation control element of the plurality of manipulation control elements, to perform the interaction operation with a target virtual object that corresponds to a particular second virtual object that is followed by the respective visual identifier indicated by the selected particular manipulation control element.

An embodiment of this disclosure provides an interaction processing apparatus. The apparatus includes processing circuitry that is configured to display, in a game interaction interface, a virtual scene that includes a first virtual object and a plurality of second virtual objects, display, based on selection of a first control element associated with an interaction operation, visual identifiers that each follow a respective second virtual object of the plurality of second virtual objects and, in a region adjacent to the first control element, a plurality of manipulation control elements that each indicate a respective visual identifier of the visual identifiers, and control, based on a selection of a particular manipulation control element of the plurality of manipulation control elements, the first virtual object to perform the interaction operation with a target virtual object that corresponds to a particular second virtual object that is followed by the respective visual identifier indicated by the selected particular manipulation control element.

An embodiment of this disclosure provides a device, including a memory and a processor. The memory is configured to store executable instructions. The processor is configured to implement, when executing the executable instructions stored in the memory, the method for interaction processing provided in embodiments of this disclosure.

An embodiment of this disclosure provides a non-transitory computer-readable storage medium, storing instructions which when executed by a processor cause the processor to perform the method for interaction processing provided in embodiments of this disclosure.

An embodiment of this disclosure provides a computer program product, including a computer program or computer-executable instructions. When the computer program or the computer-executable instructions are executed by a processor, the method for interaction processing provided in embodiments of this disclosure is implemented.

The embodiments of this disclosure may have the following beneficial effects:

The plurality of manipulation controls in one-to-one correspondence with the plurality of second virtual objects, and the binding identifier automatically following each of the second virtual objects may be displayed in the adjacent region of the first control. In addition, a manipulation control and a binding identifier of a same second virtual object include same identification information, and the plurality of manipulation controls may be in one-to-one correspondence with the plurality of second virtual objects in the virtual scene. Based on the correspondence between the manipulation controls and the second virtual objects, the player may select a manipulation control, to precisely select, from the plurality of second virtual objects, a target virtual object to be interacted with. This may facilitate an operation by the player, reduce difficulty of operation, and improve game experience of the player.

### BRIEF DESCRIPTION OF THE DRAWINGS

FIG. 1A is a schematic diagram of an application mode of an interaction processing method for a virtual scene according to an embodiment of this disclosure.

FIG. 1B is a schematic diagram of an application mode of an interaction processing method for a virtual scene according to an embodiment of this disclosure.

FIG. 2 is a schematic structural diagram of an electronic device 500 according to an embodiment of this disclosure.

FIG. 3 is a schematic flowchart of an interaction processing method for a virtual scene according to an embodiment of this disclosure.

FIG. 4A to FIG. 4D are schematic diagrams of an application scenario of an interaction processing method for a virtual scene according to an embodiment of this disclosure.

FIG. 5A and FIG. 5B are schematic flowcharts of an interaction processing method for a virtual scene according to an embodiment of this disclosure.

FIG. 6 is a schematic diagram of an application scenario of an interaction processing method for a virtual scene according to an embodiment of this disclosure.

FIG. 7A and FIG. 7B are schematic principle diagrams of an interaction processing method for a virtual scene according to an embodiment of this disclosure.

FIG. 8 is a schematic diagram of an application scenario of an interaction processing method for a virtual scene according to an embodiment of this disclosure.

FIG. 9 is a schematic flowchart of an interaction processing method for a virtual scene according to an embodiment of this disclosure.

### DESCRIPTION OF EMBODIMENTS

To make the objectives, technical solutions, and advantages of this disclosure clearer, the following describes this disclosure in further detail with reference to the accompanying drawings. The described embodiments are not to be considered as a limitation to this disclosure. Other embodiments are within the scope of this disclosure.

In the following descriptions, the term “some embodiments” describes subsets of all possible embodiments, but it may be understood that “some embodiments” may be the same subset or different subsets of all the possible embodiments, and may be combined with each other without conflict.

It may be understood that, in embodiments of this disclosure, related data (for example, data of a game character controlled by a user) such as user information is involved. When a specific product or technology is applied to this embodiment of this disclosure, a user's permission or consent is required, and acquisition, use, and processing of the relevant data need to comply with the relevant laws and standards of the relevant countries and regions.

In the following descriptions, the included term “first/second” is merely intended to distinguish similar objects but does not necessarily indicate a specific order of an object. It may be understood that “first/second” is interchangeable in terms of a specific order or sequence if permitted, so that the embodiments of this disclosure described herein can be implemented in a sequence in addition to the sequence shown or described herein.

Unless otherwise defined, meanings of all technical and scientific terms used in this specification are the same as those usually understood by a person skilled in the art to which this disclosure belongs. In this disclosure, terms used in the specification of this disclosure are merely intended to describe objectives of the specific embodiments, but are not intended to limit this disclosure.

Before the embodiments of this disclosure are further described in detail, nouns and terms involved in the embodiments of this disclosure are described. The nouns and terms provided in the embodiments of this disclosure are applicable to the following explanations.
(1) The expression “in response to” may be configured for representing a condition or status on which one or more to-be-performed operations depend. When the condition or status is met, the one or more operations may be performed immediately or have a set delay. Unless otherwise specified, there is no chronological order between the plurality of to-be-performed operations.
(2) Virtual scene: The virtual scene may be a scene displayed (or provided) when an application is run on a terminal device. The scene may be a simulated environment of a real world, may be a semi-simulated semi-fictional virtual environment, or may be an entirely fictional virtual environment. The virtual scene may be any one of a two-dimensional virtual scene, a 2.5-dimensional virtual scene, or a three-dimensional virtual scene, and the dimension of the virtual scene is not limited in the embodiments of this disclosure. For example, the virtual scene may include the sky, the land, the ocean, and the like. The land may include environmental elements such as the desert and a city. A user may control a virtual object to move in the virtual scene.
(3) Virtual object: The virtual object may be an image of each person and thing that may perform interaction in a virtual scene, or a movable object in a virtual scene. The movable object may be a virtual person, a virtual animal, a cartoon person, or the like, for example, a person or an animal displayed in the virtual scene. The virtual object may be a virtual image configured for representing a user in the virtual scene. The virtual scene may include a plurality of virtual objects, and each virtual object has a shape and a volume in the virtual scene, and occupies some space in the virtual scene.
(4) Scene data: The scene data may represent feature data of a virtual scene. For example, the scene data may be an area of a construction region in the virtual scene, a current building style of the virtual scene, or the like; or may include a position of a virtual building in the virtual scene, an area occupied by the virtual building, and the like.

A sports game (such as a basketball game) is used as an example. In a basketball game provided in the related art, a ball passing manner relies on an operation by a player. For example, the player mainly performs a sliding operation on a ball passing button. Specifically, when the player presses the ball passing button to slide, there is a connection line between a ball passer and a ball receiver, so that the player slides to select a ball receiving object and an object to be switched.

However, the solution provided in the related art is complex for ball passing or control object switching, and specific reasons are as follows: First, the player needs to slide to a direction of a specific basketballer on which the player is intended to perform ball passing. This has a high requirement on an operation by the player. In addition, positioning is not very accurate. Consequently, it is very difficult for the player to precisely find an object on which the player is intended to perform ball passing in high-tempo game experience. Second, during sliding for ball passing selection, it is difficult for the player to find a basketballer on which the player is currently intended to perform ball passing, and it is difficult to find the basketballer in an interface. Third, during ball passing, especially in a case that basketballers are close to each other, it is very difficult for the player to perform an operation, experience is complex, and it is difficult to select a basketballer.

In view of this, embodiments of this disclosure provide an interaction processing method and apparatus for a virtual scene, an electronic device, a computer-readable storage medium, and a computer program product, to efficiently and precisely select, from a plurality of virtual objects, a target virtual object to be interacted with. This facilitates an operation by a player, and improves game experience of the player. For ease of better understanding of the interaction processing method for a virtual scene provided in the embodiments of this disclosure, an example implementation scenario of the interaction processing method for a virtual scene provided in the embodiments of this disclosure is first described. In the interaction processing method for a virtual scene provided in the embodiments of this disclosure, the virtual scene may be outputted completely based on a terminal device, or may be outputted based on a terminal device and a server in a cooperative manner.

In some embodiments, the virtual scene may be an environment for virtual objects (for example, game characters) to interact. For example, the game characters fight against with each other in the virtual scene, and interaction in the virtual scene may be performed by controlling an action of the game character, so that the user can relieve the stress in life during the game.

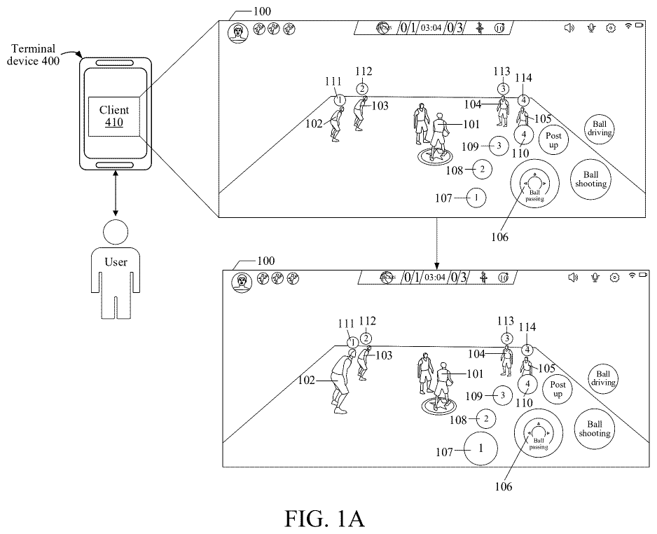

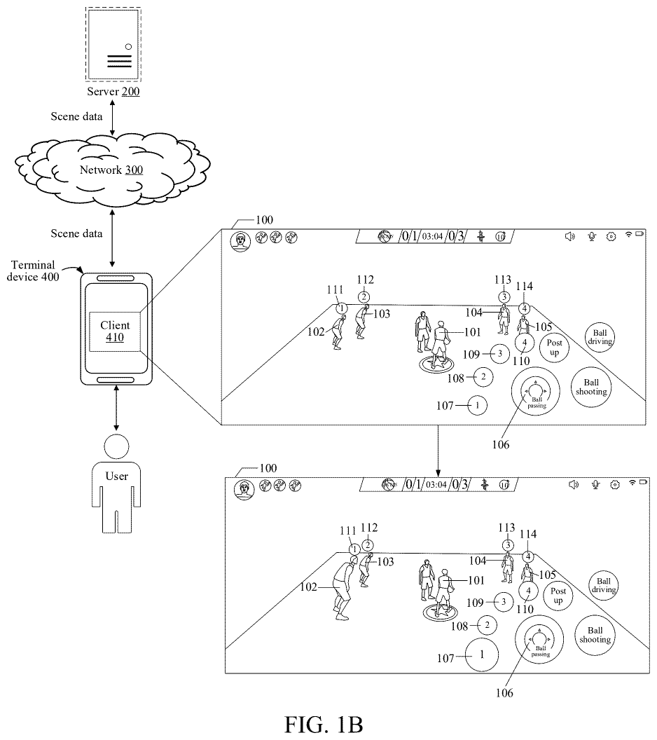

In an implementation scenario, referring to FIG. 1A, FIG. 1A is a schematic diagram of an application mode of a interaction processing method for a virtual scene according to an embodiment of this disclosure, which is applicable to some application modes in which calculation of relevant data of a virtual scene 100 is implemented completely relying on a graphics processing hardware computing capability of a terminal device 400, for example, a standalone/offline game completes the output of the virtual scene through various types of terminal devices 400 such as a smartphone, a tablet computer, and a virtual reality/augmented reality device, and the like.

For example, the graphics processing hardware includes a central processing unit (CPU) and a graphics processing unit (GPU).

When visual perception of the virtual scene 100 is formed, the terminal device 400 calculates, through graphics computing hardware, data required for display, completes loading, parsing, and rendering of the display data, and outputs a video frame capable of forming visual perception for the virtual scene on graphics output hardware, for example, displaying a two-dimensional video frame on a display screen of a smartphone, or projecting a video frame for implementing a three-dimensional display effect on lenses of augmented reality/virtual reality glasses. In addition, to enrich a perception effect, the terminal device 400 may also form one or more of auditory perception, tactile perception, motion perception, and taste perception through different hardware.

For example, the terminal device 400 runs a client 410 (for example, a standalone game application), and outputs a virtual scene including role-playing during running of the client 410. The virtual scene may be an environment for game characters to interact, for example, may be a plain, a street, a valley, a basketball court, a football field, or the like for the game characters to fight against with each other. For example, the virtual scene 100 is displayed from a third-person perspective. In the virtual scene 100, a first virtual object 101 is displayed. The first virtual object 101 may be a game character controlled by a user, that is, the first virtual object 101 is controlled by a real user, and moves in the virtual scene 100 in response to an operation by the real user on a controller (for example, a touch screen, a voice operated switch, a keyboard, a mouse, and a joystick). For example, when the real user moves the joystick to the right, the first virtual object 101 may move to the right in the virtual scene 100 or may stay still, jump, and control the first virtual object 101 to perform an operation such as shooting.

For example, the first virtual object 101 (for example, a game character A), and a plurality of second virtual objects that belong to a same camp as the first virtual object 101 are displayed in the virtual scene 100, for example, including a virtual object 102 (for example, a game character B), a virtual object 103 (for example, a game character C), a virtual object 104 (for example, a game character D), and a virtual object 105 (for example, a game character E). In addition, a first control 106 (for example, a “ball passing” button) is further displayed in the virtual scene 100. A plurality of manipulation controls in one-to-one correspondence with the plurality of second virtual objects are displayed in an adjacent region of the first control 106, for example, including a manipulation control 107 corresponding to the virtual object 102, a manipulation control 108 corresponding to the virtual object 103, a manipulation control 109 corresponding to the virtual object 104, and a manipulation control 110 corresponding to the virtual object 105. In addition, a binding identifier automatically following each of the second virtual objects may further be displayed in the virtual scene 100, including, for example, a binding identifier 111 automatically following the virtual object 102, a binding identifier 112 automatically following the virtual object 103, a binding identifier 113 automatically following the virtual object 104, and a binding identifier 114 automatically following the virtual object 105. A manipulation control and a binding identifier corresponding to a same second virtual object may include same identification information. For example, using the virtual object 103 as an example, both the manipulation control 108 and the binding identifier 112 corresponding to the virtual object 103 include a number, namely, 2. Further, the client 410 may control, in response to a manipulation control selection operation triggered by the player, the first virtual object 101 to perform, on a target virtual object, an interaction operation associated with the first control 106. For example, assuming that the player selects the manipulation control 107 from the plurality of manipulation controls, the player may zoom in the manipulation control 107, to indicate that the manipulation control 107 is a selected manipulation control. A second virtual object (namely, the virtual object 102) corresponding to the manipulation control 107 may be used as the target virtual object, and the virtual object 102 may be zoomed in, to prompt the player that the virtual object 102 is a selected virtual object. Then, the first virtual object 101 may be controlled to perform, on the virtual object 102, the interaction operation associated with the first control 106. For example, the first virtual object 101 may pass a ball to the virtual object 102.

In addition to being applied to a ball game, the technical solutions provided in the embodiments of this disclosure may further be applied to a game of another type such as a board game or a policy game. In other words, in a game in which different virtual objects interact with each other, the technical solutions provided in the embodiments of this disclosure may be used to precisely select, from a plurality of virtual objects, a target virtual object to be interacted with. This is not specifically limited in the embodiments of this disclosure.

In another implementation scenario, referring to FIG. 1B, FIG. 1B is a schematic diagram of an application mode of an interaction processing method for a virtual scene according to an embodiment of this disclosure. The method is applied to a terminal device 400 and a server 200, and is applicable to an application mode in which virtual scene calculation is completed relying on a computing capability of the server 200 and the virtual scene is outputted at the terminal device 400.

A solution for cooperative implementation of the terminal device and the server mainly involves two game modes, namely, a local game mode and a cloud game mode. The local game mode means that the terminal device and the server cooperatively run game logic processing. Some operation instructions input by a player into the terminal device are used by the terminal device to run game logic processing, and some other operation instructions are used by the server to run game logic processing. In addition, game logic processing run by the server is usually more complex and needs to consume more computing power. The cloud game mode means that game logic processing is completely run by the server, and game scene data is rendered into audio and video streams by a cloud server, and the audio and video streams are transmitted to the terminal device via a network for display. The terminal device only needs to have a basic streaming media playback capability and a capability of obtaining operation instructions of the player and sending the operation instructions to the server.

Using an example in which visual perception of a virtual scene 100 is formed, the server 200 calculates display data (for example, scene data) related to the virtual scene and sends the calculation to the terminal device 400 via a network 300, the terminal device 400 relies on graphics computing hardware to complete loading, parsing, and rendering for calculating the display data, and relies on graphics output hardware to output the virtual scene to form visual perception, for example, a two-dimensional video frame may be presented on a display screen of a smartphone, or a three-dimensional video frame may be projected on lenses of augmented reality/virtual reality glasses. For perception in the form of the virtual scene, it may be understood that, the virtual scene may be outputted through corresponding hardware of the terminal device 400, for example, auditory perception is formed by using a microphone, tactile perception is formed by using a vibrator, and the like.

For example, the terminal device 400 runs a client 410 (for example, an online game application), implements game interaction with other users by connecting to the server 200 (for example, a game server), and the terminal device 400 outputs the virtual scene 100 of the client 410. For example, the virtual scene 100 is displayed from a third-person perspective. In the virtual scene 100, a first virtual object 101 is displayed. The first virtual object 101 may be a game character controlled by a user, that is, the first virtual object 101 is controlled by a real user, and moves in the virtual scene 100 in response to an operation by the real user on a controller (for example, a touch screen, a voice operated switch, a keyboard, a mouse, and a joystick). For example, when the real user moves the joystick to the right, the first virtual object 101 may move to the right in the virtual scene 100 or may stay still, jump, and control the first virtual object 101 to perform an operation such as shooting.

For example, the first virtual object 101 (for example, a game character A), and a plurality of second virtual objects that belong to a same camp as the first virtual object 101 are displayed in the virtual scene 100, for example, including a virtual object 102 (for example, a game character B), a virtual object 103 (for example, a game character C), a virtual object 104 (for example, a game character D), and a virtual object 105 (for example, a game character E). In addition, a first control 106 (for example, a “ball passing” button) is further displayed in the virtual scene 100. A plurality of manipulation controls in one-to-one correspondence with the plurality of second virtual objects are displayed in an adjacent region of the first control 106, for example, including a manipulation control 107 corresponding to the virtual object 102, a manipulation control 108 corresponding to the virtual object 103, a manipulation control 109 corresponding to the virtual object 104, and a manipulation control 110 corresponding to the virtual object 105. In addition, a binding identifier automatically following each of the second virtual objects may further be displayed in the virtual scene 100, including, for example, a binding identifier 111 automatically following the virtual object 102, a binding identifier 112 automatically following the virtual object 103, a binding identifier 113 automatically following the virtual object 104, and a binding identifier 114 automatically following the virtual object 105. A manipulation control and a binding identifier corresponding to a same second virtual object may include same identification information. For example, using the virtual object 103 as an example, both the manipulation control 108 and the binding identifier 112 corresponding to the virtual object 103 include a number, namely, 2. Further, the client 410 may control, in response to a manipulation control selection operation triggered by the player, the first virtual object 101 to perform, on a target virtual object, an interaction operation associated with the first control 106. For example, assuming that the player selects the manipulation control 107 from the plurality of manipulation controls, the player may zoom in the manipulation control 107, to indicate that the manipulation control 107 is a selected manipulation control. A second virtual object (namely, the virtual object 102) corresponding to the manipulation control 107 may be used as the target virtual object, and the virtual object 102 may be zoomed in, to prompt the player that the virtual object 102 is a selected virtual object. Then, the first virtual object 101 may be controlled to perform, on the virtual object 102, the interaction operation associated with the first control 106. For example, the first virtual object 101 may pass a ball to the virtual object 102.

In some embodiments, the terminal device 400 may further implement the interaction processing method for a virtual scene provided in the embodiments of this disclosure by running a computer program, for example, the computer program may be a native program or software module in an operating system; a native application (APP), that is, an application that needs to be installed in the operating system for running, for example, a sports game APP (that is, the foregoing client 410); a mini program, that is, a program that can be run simply by downloading the program into a browser environment; or a game mini program that can be embedded into any APP. Based on the above, the computer program may be an application, module, or plug-in in any form.

For example, the computer program is an application. During actual implementation, an application supporting a virtual scene is installed and run on the terminal device 400. The application may be any one of a first-person shooting game (FPS), a third-person shooting game, a virtual reality application, a three-dimensional map program, a card strategy game, a sports game, or a multiplayer gunfight survival game. The user uses the terminal device 400 to operate a virtual object in a virtual scene to perform activities. The activities include, but not limited to, at least one of adjusting body postures, crawling, walking, running, riding, jumping, driving, picking, shooting, attacking, throwing, and constructing a virtual building. For example, the virtual character may be a virtual person, for example, a simulated person character or a cartoon person character.

In some other embodiments, the embodiments of this disclosure may further be implemented by using a cloud technology. The cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on an application of a cloud computing business mode, and may form a resource pool, which is used as required, and is flexible and convenient. A cloud computing technology becomes an important support. A background service of a technical network system requires a large amount of computing and storage resources.

For example, the server 200 in FIG. 1B may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device 400 may be a smartphone, a tablet computer, a notebook computer, a desktop computer, a smart speaker, a smartwatch, an in-vehicle terminal, a virtual reality (VR) device, or the like, but is not limited thereto. The terminal device 400 and the server 200 may be directly or indirectly connected in a wired or wireless communication manner. This is not limited in this embodiment of this disclosure.

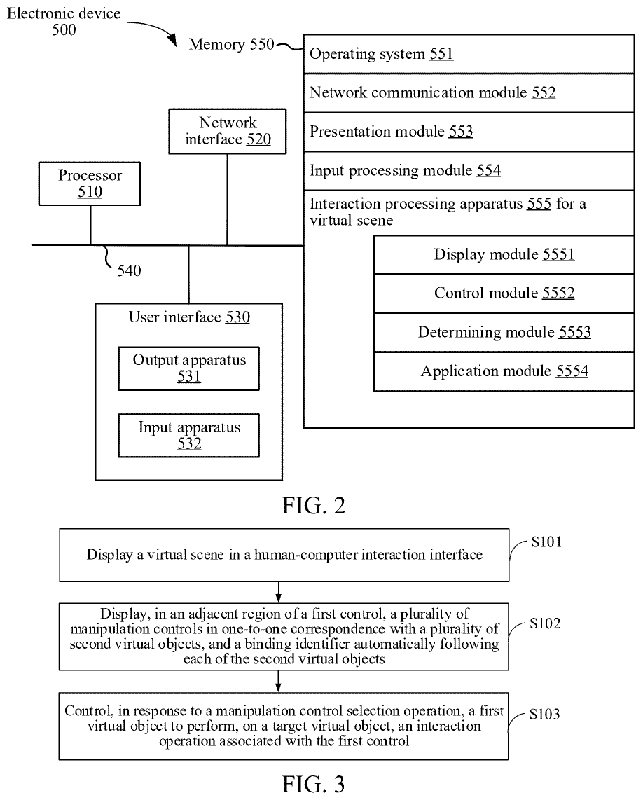

A structure of the electronic device provided in the embodiments of this disclosure is described below. For example, the electronic device is a terminal device. Refer to FIG. 2. FIG. 2 is a schematic structural diagram of an electronic device 500 according to an embodiment of this disclosure. The electronic device 500 may be a terminal device. The electronic device 500 shown in FIG. 2 includes: at least one processor 510, a memory 550, at least one network interface 520, and a user interface 530. All the components in the electronic device 500 are coupled together by using a bus system 540. It may be understood that the bus system 540 is configured to implement connection and communication between the components. In addition to a data bus, the bus system 540 further includes a power bus, a control bus, and a status signal bus. However, for ease of clear description, all types of buses are marked as the bus system 540 in FIG. 2.

The processor 510 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any conventional processor, or the like.

The user interface 530 includes one or more output apparatuses 531 that enable presentation of media content, including one or more speakers and/or one or more visualization displays. The user interface 530 further includes one or more input apparatuses 532, including user interface components helping a user input, such as a keyboard, a mouse, a microphone, a touch display screen, a camera, and other input buttons and controls.

The memory 550 may be a removable memory, a non-removable memory, or a combination thereof. Exemplary hardware devices include a solid-state memory, a hard disk drive, an optical disc driver, or the like. The memory 550 includes one or more storage devices physically away from the processor 510.

The memory 550 includes a volatile memory or a non-volatile memory, or may include both a volatile memory and a non-volatile memory. The non-volatile memory may be a read-only memory (ROM), and the volatile memory may be a random access memory (RAM). The memory 550 described in the embodiments of this disclosure is to include any other suitable type of memories.

In some embodiments, the memory 550 may store data to support various operations. Examples of the data include programs, modules, and data structures, or a subset or a superset thereof. The descriptions are made below by using examples.

An operating system 551 includes a system program configured to process various basic system services and perform a hardware-related task, for example, a framework layer, a core library layer, and a driver layer, and is configured to implement various basic services and process a hardware-related task.

A network communication module 552 is configured to reach another computing device through one or more (wired or wireless) network interfaces 520. Exemplary network interfaces 520 include: Bluetooth, wireless compatible authentication (Wi-Fi), a universal serial bus (USB), and the like.

A presentation module 553 is configured to present information through an output apparatus 531 (for example, a display screen or a speaker) associated with one or more user interfaces 530 (for example, a user interface configured to operate a peripheral device and display content and information).

An input processing module 554 is configured to detect one or more user inputs or interactions from one of the one or more input apparatuses 532 and translate the detected input or interaction.

In some embodiments, the apparatus provided in the embodiments of this disclosure may be implemented in a form of software. FIG. 2 shows an interaction processing apparatus 555 for a virtual scene stored in the memory 550, which may be software in a form such as a program and a plug-in, and includes the following software modules: a display module 5551, a control module 5552, a determining module 5553, and an application module 5554. Such modules are logical, and therefore may be combined in various manners or further divided based on a function to be implemented. For ease of description, FIG. 2 shows all the modules at a time. However, the interaction processing apparatus 555 for a virtual scene shall not be construed as excluding the implementation that only the display module 5551 and the control module 5552 are included, and functions of the modules are described below.

The interaction processing method for a virtual scene provided in the embodiments of this disclosure is described in detail below with reference to an exemplary disclosure and implementation of the terminal device provided in the embodiments of this disclosure.

For example, referring to FIG. 3, FIG. 3 is a schematic flowchart of an interaction processing method for a virtual scene according to an embodiment of this disclosure. Descriptions are given below with reference to operations shown in FIG. 3.

The method shown in FIG. 3 may be performed by computer programs in various forms run on a terminal device. This is not limited to a client. For example, the computer program may alternatively be the operating system, the software module, a script, and a mini program. Therefore, an example of the client in the following shall not be construed as a limitation to this embodiment of this disclosure. In addition, for ease of description, the terminal device and the client run on the terminal device are not specifically distinguished below.

Operation S101: Display a virtual scene in a human-computer interaction interface. In an example, a virtual scene that includes a first virtual object and a plurality of second virtual objects is displayed in a game interaction interface.

The virtual scene may include a first virtual object and a plurality of second virtual objects. The first virtual object is a virtual object manipulated (by a current player) in the human-computer interaction interface, and the plurality of second virtual objects may be virtual objects manipulated by a robot program or another player. In addition, the plurality of second virtual objects and the first virtual object may belong to a same camp.

In some embodiments, a client (for example, a sports game APP) supporting a virtual scene is installed on the terminal device. When a user opens the client installed on the terminal device (for example, the terminal device receives a tap operation by the user on an icon corresponding to the sports game APP presented on a desktop), and the terminal device runs the client, the virtual scene may be displayed in the human-computer interaction interface of the client. The virtual scene may include the first virtual object and the plurality of second virtual objects belonging to the same camp as the first virtual object.

In some other embodiments, the virtual scene may be displayed in the human-computer interaction interface of the client from a first-person perspective (for example, a virtual object in the game is played from a perspective of the user); the virtual scene may be displayed from a third-person perspective (for example, the user runs after a virtual object in the game to play the game); or the virtual scene may be displayed from a bird's eye view, where the bird's eye view is a lens perspective using a bird's perspective of flying in the sky. The foregoing different perspectives may be randomly switched.

For example, the first virtual object may be an object controlled by the current user in the game. Certainly, the virtual scene may further include other virtual objects, for example, the second virtual objects that may be controlled by the another user or the robot program. The virtual object may be divided into any one of a plurality of camps, the camps may be in an opposing relationship or a cooperative relationship, and camps in the virtual scene may include one or both of the foregoing relationships.

Using an example in which the virtual scene is displayed from the first-person perspective, the displaying a virtual scene in a human-computer interaction interface may include: determining a field of view region of the first virtual object based on a viewing position and a field of view of the first virtual object in an entire virtual scene, and presenting a part of the virtual scene in the field of view region in the entire virtual scene, that is, the displayed virtual scene may be a part of the virtual scene relative to a panoramic virtual scene. The first-person perspective is a viewing perspective that brings the most impact for the user. In this way, user's immersive perception during operation can be achieved.

Using an example in which the virtual scene is displayed from the bird's-eye view, the displaying a virtual scene in a human-computer interaction interface may include: presenting a part of the virtual scene corresponding to a zooming operation in the human-computer interaction interface in response to the zooming operation on a panoramic virtual scene, that is, the displayed virtual scene may be a part of the virtual scene relative to the panoramic virtual scene. In this way, operability of the user during operation can be improved, thereby improving efficiency of human-computer interaction.

Operation S102: Display, in an adjacent region of a first control, a plurality of manipulation controls in one-to-one correspondence with the plurality of second virtual objects, and a binding identifier automatically following each of the second virtual objects. In an example, visual identifiers that each follow a respective second virtual object of the plurality of second virtual objects and, in a region adjacent to the first control element, a plurality of manipulation control elements that each indicate a respective visual identifier of the visual identifiers are displayed based on selection of a first control element associated with an interaction operation.

A manipulation control and a binding identifier corresponding to a same second virtual object includes same identification information (for example, a number and a name). For example, the second virtual object is a virtual object B. An icon of a manipulation control of the virtual object B may include a same number as a binding identifier of the virtual object B, for example, both the icon of the manipulation control and the binding identifier corresponding to the virtual object B are 1.

In some embodiments, the first control may be a triggered control in a plurality of candidate controls displayed in the human-computer interaction interface, and operation S102 may be implemented as follows: A triggered candidate control in the plurality of candidate controls is identified as the first control in response to a control trigger operation (for example, a tap operation, a double-tap operation, a leftward sliding operation, or a rightward sliding operation), and the plurality of manipulation controls in one-to-one correspondence with the plurality of second virtual objects, and the binding identifier automatically following each of the second virtual objects are displayed in the adjacent region of the first control.

The plurality of candidate controls may include the first control and at least one second control, where a type of the second control includes at least one of the following: a control associated with a prop throwing function (for example, a “ball shooting” button) and a control associated with a virtual object crossing function (for example, a “ball driving” button).

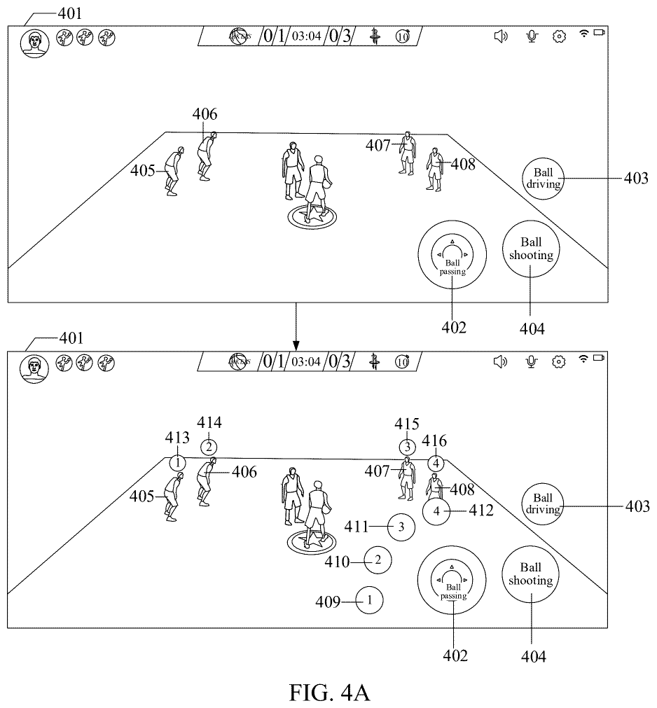

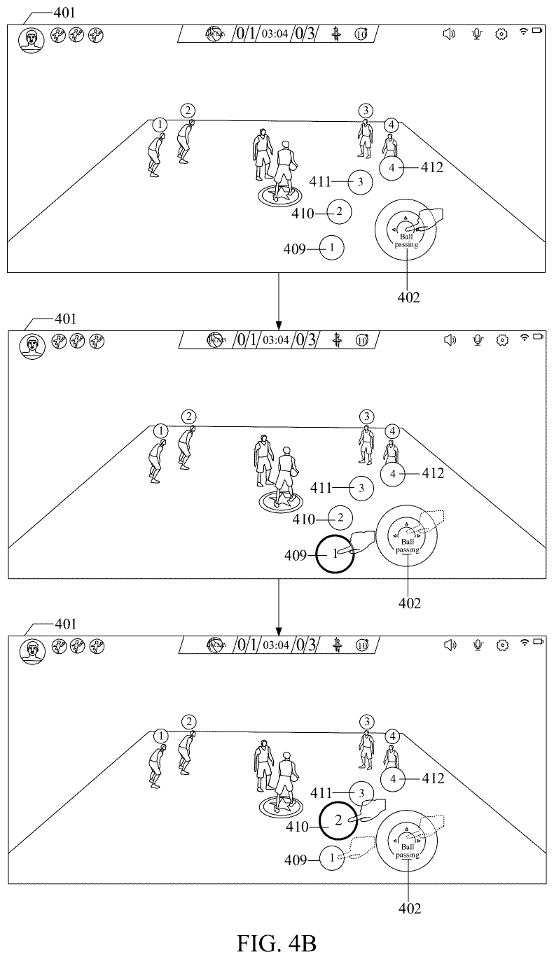

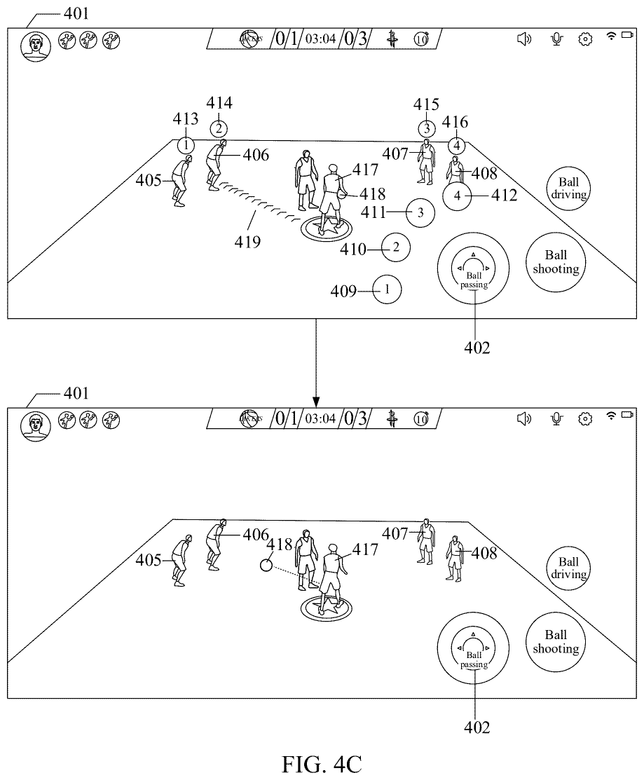

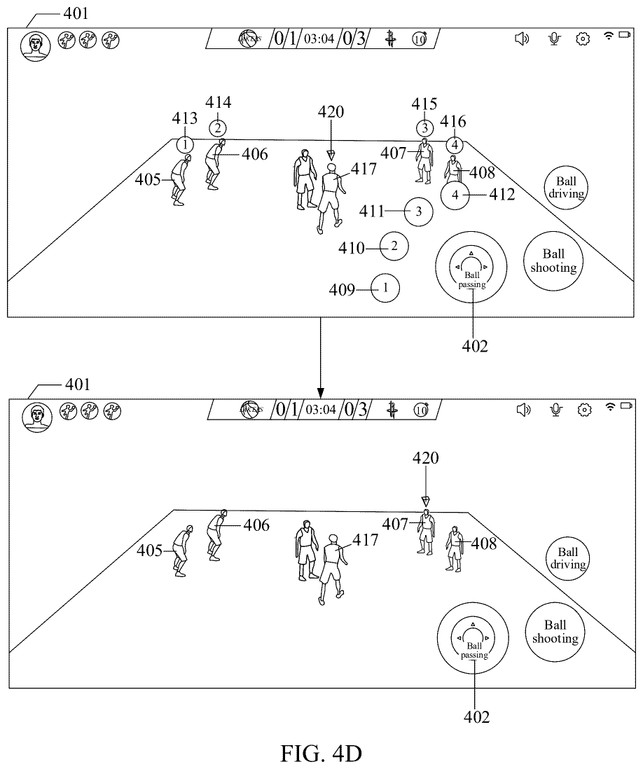

A basketball game is used as an example. Refer to FIG. 4A. FIG. 4A is a schematic diagram of an application scenario of an interaction processing method for a virtual scene according to an embodiment of this disclosure. As shown in FIG. 4A, a plurality of candidate controls are displayed in a virtual scene 401, including, for example, a “ball passing” button 402, a “ball driving” button 403, and a “ball shooting” button 404. When a tap operation by a player on the “ball passing” button 402 is received, a plurality of manipulation controls in one-to-one correspondence with a plurality of second virtual objects, and a binding identifier automatically following each of the second virtual objects may be displayed in an adjacent region of the “ball passing” button 402. For example, a manipulation control 409 corresponding to a game character 405 (where corresponding identification information, for example, a number 1, is displayed in the manipulation control 409), a manipulation control 410 corresponding to a game character 406 (where corresponding identification information, for example, a number 2, is displayed in the manipulation control 410), a manipulation control 411 corresponding to a game character 407 (where corresponding identification information, for example, a number 3, is displayed in the manipulation control 411), a manipulation control 412 corresponding to a game character 408 (where corresponding identification information, for example, a number 4, is displayed in the manipulation control 412), and a binding identifier 413 automatically following the game character 405 (where identification information, for example, the number 1, the same as that included in the manipulation control 409 is displayed in the binding identifier 413), a binding identifier 414 automatically following the game character 406 (where identification information, for example, the number 2, the same as that included in the manipulation control 410 is displayed in the binding identifier 414), a binding identifier 415 automatically following the game character 407 (where identification information, for example, the number 3, the same as that included in the manipulation control 411 is displayed in the binding identifier 415), and a binding identifier 416 automatically following the game character 408 (where identification information, for example, the number 4, the same as that included in the manipulation control 412 is displayed in the binding identifier 416) may be displayed around the “ball passing” button 402. In other words, there is a one-to-one correspondence between the plurality of manipulation controls and the plurality of second virtual objects, and there is a one-to-one correspondence between the plurality of binding identifiers and the plurality of second virtual objects. In this way, the player may intuitively make the plurality of manipulation controls be in one-to-one correspondence with the plurality of second virtual objects in the virtual scene based on the binding identifier automatically following each of the second virtual objects, to facilitate an operation by the player, and further improve game experience of the player.

Compared with the solution in the related art in which the player needs to select a virtual object based on a position of the virtual object, in this embodiment of this disclosure, only a manipulation control is selected based on a correspondence between binding identifiers, manipulation controls, and virtual objects, so that a virtual object moving in the virtual scene can be selected. This reduces difficulty of operation by the player, and improves efficiency of human computer interaction. Compared with the solution in the related art in which a tap control needs to be configured for a dynamic virtual object, a manipulation control is configured near the first control, and the manipulation control is not continuously displayed, so that computing resources for control display are saved.

In some embodiments, the plurality of manipulation controls in one-to-one correspondence with the plurality of second virtual objects, and the binding identifier automatically following each of the second virtual objects may alternatively be automatically displayed, and operation S102 may further be implemented as follows: The plurality of manipulation controls in one-to-one correspondence with the plurality of second virtual objects, and the binding identifier automatically following each of the second virtual objects are displayed in the adjacent region of the first control in response to that a display condition is met, where the display condition includes at least one of the following: an automatic display period reaches (for example, 30 s, that is, the plurality of manipulation controls in one-to-one correspondence with the plurality of second virtual objects, and the binding identifier automatically following each of the second virtual objects may be automatically displayed in the adjacent region of the first control every 30 s) or the first virtual object enters a specific position in the virtual scene (for example, a scoring position, including positions such as low post and a three-point-line shooting position).

A basketball game is used as an example. Each time the automatic display period reaches (for example, every 30 s), the plurality of manipulation controls in one-to-one correspondence with the plurality of second virtual objects (for example, other basketballers belonging to a same team as a basketballer currently controlled by the player) and the binding identifier automatically following each of the second virtual objects may be automatically displayed in the adjacent region of the first control (for example, a “ball passing” button). In addition, when a selection operation triggered by the player on the plurality of manipulation controls is not received within waiting time (for example, 10 s), it indicates that the player currently does not have a need to select another character for interaction. To avoid interference to a current operation by the player, the display of the plurality of manipulation controls in one-to-one correspondence with the plurality of second virtual objects, and the binding identifier automatically following each of the second virtual objects in the adjacent region of the first control may be canceled.

In some other embodiments, the display of the plurality of manipulation controls in one-to-one correspondence with the plurality of second virtual objects in the adjacent region of the first control may alternatively be implemented as follows: The plurality of manipulation controls in one-to-one correspondence with the plurality of second virtual objects are displayed in the adjacent region of the first control in a specific sorting manner, where the sorting manner includes: an order in which current positions of the plurality of second virtual objects are arranged in a specific direction (for example, an order from left to right or an order from right to left); an order in which preset locations of the plurality of second virtual objects in a camp to which the plurality of second virtual objects belong are arranged in a specific direction (for example, an order of a forward, a center, and a guard); an ascending order or a descending order of interaction frequencies between the plurality of second virtual objects and the first virtual object (for example, a manipulation control corresponding to a second virtual object having a higher interaction frequency with the first virtual object ranks higher in the plurality of manipulation controls, making it convenient for the player to select a virtual object that the player most frequently interacts with); an ascending order or a descending order of differences between moments at which the plurality of second virtual objects interact with the first virtual object last time and a current moment (for example, a manipulation control corresponding to a second virtual object whose interaction with the first virtual object last time is closer to the current moment ranks higher in the plurality of manipulation controls, making it convenient for the player to select a virtual object that the player most recently interacts with); and an ascending order or a descending order of distances between the plurality of second virtual objects and the first virtual object (for example, a manipulation control corresponding to a second virtual object having a shorter distance from the first virtual object ranks higher in the plurality of manipulation controls, making it convenient for the player to select a virtual object closet to the player).

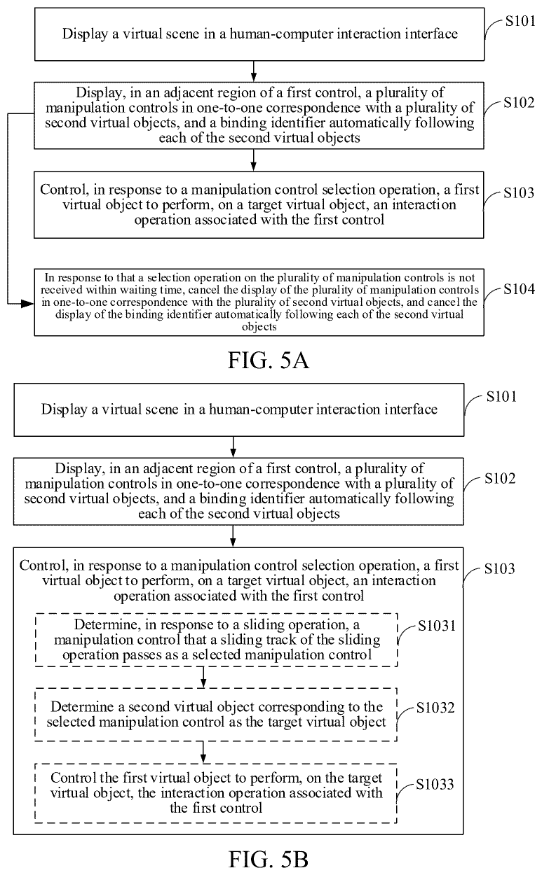

In some embodiments, referring to FIG. 5A, FIG. 5A is a schematic flowchart of an interaction processing method for a virtual scene according to an embodiment of this disclosure. As shown in FIG. 5A, after operation S102 in FIG. 3 is performed, operation S104 shown in FIG. 5A may be performed. Descriptions are given below with reference to operations shown in FIG. 5A.

Operation S104: In response to that a selection operation on the plurality of manipulation controls is not received within waiting time, cancel the display of the plurality of manipulation controls in one-to-one correspondence with the plurality of second virtual objects, and cancel the display of the binding identifier automatically following each of the second virtual objects.

In some embodiments, after the plurality of manipulation controls in one-to-one correspondence with the plurality of second virtual objects, and the binding identifier automatically following each of the second virtual objects are displayed in the adjacent region of the first control, if the selection operation triggered by the player on the plurality of manipulation controls is not received within the waiting time (for example, 10 s), it indicates that the player currently does not have a need to select a target virtual object for interaction, and in this case, the display of the plurality of manipulation controls in one-to-one correspondence with the plurality of second virtual objects may be canceled, and the display of the binding identifier automatically following each of the second virtual objects may be canceled. In this way, blocking of the identifiers in the human-computer interaction interface to the virtual scene is reduced, interference caused by the display of the manipulation controls and the binding identifiers to a current operation by the player can be avoided, and computing resources required by a processor for displaying the virtual scene can be saved.

Still refer to FIG. 3. Operation S103: Control, in response to a manipulation control selection operation, the first virtual object to perform, on a target virtual object, an interaction operation associated with the first control. In an example, the first virtual object is controlled, based on a selection of a particular manipulation control element of the plurality of manipulation control elements, to perform the interaction operation with a target virtual object that corresponds to a particular second virtual object that is followed by the respective visual identifier indicated by the particular manipulation control element that was selected.

The target virtual object is a second virtual object corresponding to a selected manipulation control.

For example, a function for performing an interaction operation is bound to the first control. When the manipulation control is triggered, the interaction operation bound to the first control is performed on the target virtual object.

In some embodiments, to help the player to determine a selected virtual object, the following processing may further be performed: applying, for the selected manipulation control, a display manner different from that of another manipulation control (for example, the selected manipulation control may be zoomed in), and applying, for the target virtual object, a display manner different from that of another second virtual object (for example, the target virtual object may be zoomed in).

For example, a quantity of the plurality of manipulation controls is four, namely, a manipulation control 1, a manipulation control 2, a manipulation control 3, and a manipulation control 4, where the manipulation control 1 is a manipulation control corresponding to a virtual object A, the manipulation control 2 is a manipulation control corresponding to a virtual object B, the manipulation control 3 is a manipulation control corresponding to a virtual object C, and the manipulation control 4 is a manipulation control corresponding to a virtual object D. When the player selects the manipulation control 2 from the plurality of manipulation controls, the manipulation control 2 may be zoomed in, to indicate that the manipulation control 2 is a manipulation control currently selected by the player, and a second virtual object (namely, the virtual object B) corresponding to the manipulation control 2 may further be zoomed in, to indicate that the virtual object B is a selected virtual object. In this way, the selected manipulation control is displayed in the display manner different from that of the another manipulation control, and the target virtual object is displayed in the display manner different from that of the another second virtual object, to help the player to determine a currently selected virtual object. This improves game experience of the player.

In some embodiments, the manipulation control selection operation may be a tap operation or a drag operation. For example, the player may first tap the first control, release the first control, tap a manipulation control, and determine the tapped manipulation control as the selected manipulation control. For another example, the player may first tap the first control, and drag the first control to the selected manipulation control.

In some embodiments, the manipulation control selection operation may be a sliding operation, and the sliding operation and the control triggering operation (for example, the tap operation) may not be continuous (for example, the player may first tap the first control, release the first control, and then perform the sliding operation). Refer to FIG. 5B. FIG. 5B is a schematic flowchart of an interaction processing method for a virtual scene according to an embodiment of this disclosure. Operation S103 shown in FIG. 3 may be implemented by performing operation S1031 to operation S1033 shown in FIG. 5B. Descriptions are given below with reference to operations shown in FIG. 5B.

Operation S1031: Determine, in response to the sliding operation, a manipulation control that a sliding track of the sliding operation passes as the selected manipulation control.

In some embodiments, operation S1031 may be implemented as follows: Display of the selected manipulation control is refreshed based on the manipulation control that the sliding track of the sliding operation current passes (for example, assuming that the sliding track of the sliding operation currently passes the manipulation control 1, the manipulation control 1may be zoomed in, to indicate that the manipulation control 1 is a currently selected manipulation control; and assuming that the sliding track passes from the manipulation control 1 to the manipulation control 2 as the player continues to perform the sliding operation, the manipulation control 1 may be canceled to be zoomed in, and the manipulation control 2 may be zoomed in, to indicate that the manipulation control 2 is a currently selected manipulation control). A selected manipulation control whose display is finally refreshed is determined as a finally selected manipulation control in response to that the sliding operation is released (for example, assuming that when the sliding operation is released, the manipulation control that the sliding track of the sliding operation finally passes is the manipulation control 3, the manipulation control 3 may be zoomed in, and the manipulation control 3 is used as the finally selected manipulation control).

For example, referring to FIG. 4B, FIG. 4B is a schematic diagram of an application scenario of an interaction processing method for a virtual scene according to an embodiment of this disclosure. As shown in FIG. 4B, when a tap operation performed by the player on a first control 402 (for example, the “ball passing” button) is received, the plurality of manipulation controls, for example, including the manipulation control 409, the manipulation control 410, the manipulation control 411, and the manipulation control 412, in one-to-one correspondence with the plurality of second virtual objects may be displayed in an adjacent region of the first control 402. Then, assuming that a sliding operation performed by the player on the first control 402 is received, and a sliding track of the sliding operation currently passes the manipulation control 409, the manipulation control 409 may be zoomed in and highlighted, to indicate that the manipulation control 409 is a manipulation control currently selected by the player; and assuming that the sliding track of the sliding operation subsequently passes the manipulation control 410 as the player continues to perform the sliding operation, the manipulation control 409 may be zoomed out, highlighting of the manipulation control 409 may be canceled, and the manipulation control 410 is zoomed in and highlighted, to indicate that the manipulation control 410 is a manipulation control currently selected by the player. Then, assuming that it is detected that the sliding operation triggered by the player is released, the manipulation control 410 may be used as a manipulation control finally selected by the player.

Operation S1032: Determine the second virtual object corresponding to the selected manipulation control as the target virtual object.

In some embodiments, after the selected manipulation control is determined, the second virtual object corresponding to the selected manipulation control may be determined as the target virtual object (that is, a virtual object that needs to interact with the first virtual object).

Operation S1033: Control the first virtual object to perform, on the target virtual object, the interaction operation associated with the first control.

In some embodiments, the first control may be associated with a prop passing function (such as a ball passing function), and the first virtual object may hold a virtual prop (such as a virtual basketball or a virtual football). Operation S1033 may be implemented as follows: The first virtual object is controlled to pass the virtual prop to the target virtual object.

In some other embodiments, when the first virtual object is controlled to perform, on the target virtual object, the interaction operation associated with the first control, the following processing may be further performed: canceling the display of the plurality of manipulation controls in one-to-one correspondence with the plurality of second virtual objects, and canceling the display of the binding identifier automatically following each of the second virtual objects. In this way, interference caused by continuous display of the manipulation controls and the binding identifiers to a subsequent operation by the player can be avoided.

For example, referring to FIG. 4C, FIG. 4C is a schematic diagram of an application scenario of an interaction processing method for a virtual scene according to an embodiment of this disclosure. As shown in FIG. 4C, a first virtual object 417 (for example, a game character 1 currently manipulated by the player) is displayed in the virtual scene 401, and the first virtual object 417 holds a virtual prop 418 (for example, a target for which different camps in the virtual scene contest, and using a basketball game as an example, the virtual prop may be a virtual basketball). When a manipulation control selection operation triggered by the player on the plurality of manipulation controls (for example, including the manipulation control 409 to the manipulation control 412) displayed in the adjacent region of the first control 402 (for example, the “ball passing” button) is received, for example, assuming that the player selects the manipulation control 410 from the plurality of manipulation controls (for example, the sliding track of the sliding operation triggered by the player passes the manipulation control 410), the game character 406 (for example, a game character 2) corresponding to the manipulation control 410 may be used as the target virtual object, and a connection line 419 between the first virtual object 417 and the game character 406 is displayed, to inform the player that an object on which ball passing is to be performed is the game character 406. Then, when it is detected that the sliding operation triggered by the player is released, the first virtual object 417 may be controlled to pass the virtual prop 418 to the game character 406, for example, the game character 1 is controlled to pass a ball to the game character 2.

When the first virtual object 417 is controlled to pass the virtual prop 418 to the game character 406, the display of the plurality of manipulation controls and the binding identifier automatically following each of the second virtual objects may be canceled (for example, the display of the manipulation control 409 to the manipulation control 412 may be canceled, and the display of the binding identifier 413 automatically following the game character 405, the binding identifier 414 automatically following the game character 406, the binding identifier 415 automatically following the game character 407, and the binding identifier 416 automatically following the game character 408 may be canceled), to avoid interference to a subsequent operation by the player. When the tap operation by the player on the first control 402 is subsequently received again, the plurality of manipulation controls in one-to-one correspondence with the plurality of second virtual objects, and the binding identifier automatically following each of the second virtual objects may be displayed in the adjacent region of the first control 402 again.

In some other embodiments, the first control may further be associated with a control switching function, and a control identifier automatically follows the first virtual object. The control identifier indicates that the first virtual object is a virtual object in the human-computer interaction interface currently manipulated (by the player). Operation S1033 may further be implemented as follows: The control identifier is switched from the first virtual object to the target virtual object, so that the control identifier automatically follows the target virtual object, to indicate that the target virtual object is the virtual object in the human-computer interaction interface currently manipulated (by the player).

For example, referring to FIG. 4D, FIG. 4D is a schematic diagram of an application scenario of an interaction processing method for a virtual scene according to an embodiment of this disclosure. As shown in FIG. 4D, a first virtual object 417 (for example, a game character 1) and a control identifier 420 automatically following the first virtual object 417 are displayed in the virtual scene 401, to indicate that the first virtual object 417 is a virtual object currently manipulated by the player in the virtual scene 401 (that is, a game character currently manipulated by the player is the game character 1). When a manipulation control selection operation triggered by the player on the plurality of manipulation controls (for example, including the manipulation control 409 to the manipulation control 412) displayed in the adjacent region of the first control 402 (for example, the “ball passing” button) is received, for example, assuming that the player selects the manipulation control 411 from the plurality of manipulation controls (for example, assuming that the sliding track of the sliding operation triggered by the player passes the manipulation control 411), a game character 415 corresponding to the manipulation control 411 is used as the target virtual object, and the control identifier 420 is switched from the first virtual object 417 to the game character 415, so that the control identifier 420 automatically follows the game character 415, to indicate that the game character 415 is the virtual object currently manipulated by the player in the virtual scene 401. In this way, the player can conveniently switch from controlling the first virtual object 417 to controlling the game character 415, to improve game experience of the player.

When the control identifier 420 is switched from the first virtual object 417 to the game character 415, the display of the plurality of manipulation controls and the binding identifier automatically following each of the second virtual objects may be canceled in the virtual scene 401, for example, the display of the manipulation control 409 to the manipulation control 412 and the display of the binding identifier 413 automatically following the game character 405, the binding identifier 414 automatically following the game character 406, the binding identifier 415 automatically following the game character 407, and the binding identifier 416 automatically following the game character 408 may be canceled in the adjacent region of the first control 402. When the tap operation by the player on the first control 402 is subsequently received again, the plurality of manipulation controls in one-to-one correspondence with the plurality of second virtual objects, and the binding identifier automatically following each of the second virtual objects may be displayed in the adjacent region of the first control 402 again.

In some embodiments, still using the foregoing example, the following processing may further be performed: in the adjacent region of the first control in response to that the sliding operation is released and the sliding track of the sliding operation does not pass any manipulation control, canceling the display of the plurality of manipulation controls in one-to-one correspondence with the plurality of second virtual objects, and canceling the display of the binding identifier automatically following each of the second virtual objects.

For example, a basketball game is used as an example. When a tap operation by the player on a “ball passing” button (that is, the first control) is received, a plurality of manipulation controls in one-to-one correspondence with a plurality of teammate characters (that is, the second virtual objects), and a binding identifier automatically following each of the teammate characters are displayed in an adjacent region of the “ball passing” button. Then, assuming that a sliding operation triggered by the player is received, but before the sliding operation is released, a sliding track of the sliding operation does not pass any manipulation control (that is, the player does not select any manipulation control), it indicates that the player currently does not have a need to select another virtual object for interaction. In this case, the display of the plurality of manipulation controls and the binding identifier automatically following each of the teammate characters may be canceled.

When the manipulation control selection operation is the sliding operation, the following processing may further be performed: displaying the sliding track of the sliding operation in the human-computer interaction interface in real time. In this way, the player may intuitively determine a currently selected manipulation control based on the sliding track displayed in the human-computer interaction interface in real time.

In some other embodiments, the control triggering operation may be a tap operation, and the manipulation control selection operation may be the sliding operation. Operation S103 may alternatively be implemented as follows: In a case that the tap operation is not released, a manipulation control that a sliding track of the sliding operation passes is determined as the selected manipulation control in response to the sliding operation performed from a touch point of the tap operation, and the second virtual object corresponding to the selected manipulation control is determined as the target virtual object; and The first virtual object is controlled to perform, on the target virtual object, the interaction operation associated with the first control. In this way, control selection and object selection may be integrated into one operation, thereby further improving efficiency of human computer interaction.

In some embodiments, the manipulation control selection operation may alternatively be a tap operation, and operation S103 may alternatively be implemented as follows: A tapped manipulation control is used as the selected manipulation control in response to the tap operation, and the second virtual object corresponding to the selected manipulation control is determined as the target virtual object; and the first virtual object is controlled to perform, on the target virtual object, the interaction operation associated with the first control.

For example, a basketball game is used as an example. A “ball passing” button (that is, the first control) is displayed in the virtual scene (for example, a basketball court). When a tap operation by the player on the “ball passing” button is received, a plurality of manipulation controls (for example, including the manipulation control 1 to the manipulation control 4, where the manipulation control 1 corresponds to a teammate character 1, the manipulation control 2corresponds to a teammate character 2, the manipulation control 3 corresponds to a teammate character 3, and the manipulation control 4 corresponds to a teammate character 4) in one-to-one correspondence with a plurality of teammate characters (that is, the second virtual objects), and a binding identifier automatically following each of the teammate characters are displayed in an adjacent region of the “ball passing” button. Then, assuming that a tap operation by the player on the manipulation control 2 is received, the manipulation control 2 may be used as a selected manipulation control, and a teammate character (that is, the teammate character 2) corresponding to the manipulation control 2 is used as the target virtual object, and then the first virtual object may be controlled to pass a ball to the teammate character 2.

In some other embodiments, after the plurality of manipulation controls in one-to-one correspondence with the plurality of second virtual objects, and the binding identifier automatically following each of the second virtual objects are displayed in the adjacent region of the first control, and before the manipulation control selection operation is responded to, the following processing may be further performed: controlling the plurality of manipulation controls in one-to-one correspondence with the plurality of second virtual objects, and the binding identifier automatically following each of the second virtual objects to remain unchanged. In this way, no disorder due to movement of the second virtual objects is caused, thereby improving game experience of the player.

In some embodiments, the following processing may further be performed: updating, in response to an identifier editing operation, the display of the plurality of manipulation controls in one-to-one correspondence with the plurality of second virtual objects, and the binding identifier automatically following each of the second virtual objects; and updating, in response to that an identifier update condition is met, the display of the plurality of manipulation controls in one-to-one correspondence with the plurality of second virtual objects, and the binding identifier automatically following each of the second virtual objects, where the identifier update condition includes that a motion range of any one of the second virtual objects changes.

A basketball game is used as an example. A “ball passing” button (that is, the first control) is displayed in the virtual scene. When a tap operation by the player on the “ball passing” button is received, a plurality of manipulation controls in one-to-one correspondence with a plurality of teammate characters, and a binding identifier automatically following each of the teammate characters are displayed in an adjacent region of the “ball passing” button. In this case, the player may further manually edit the plurality of manipulation controls, for example, the player may adjust a display order of the plurality of manipulation controls, or adjust identification information included in the manipulation controls. The client updates display of a plurality of edited manipulation controls in response to an identifier editing operation triggered by the player and updates the display of the binding identifier automatically following each of the teammate characters.

For example, a basketball game is used as an example. A “ball passing” button (that is, the first control) is displayed in the virtual scene. When a tap operation by the player on the “ball passing” button is received, a plurality of manipulation controls in one-to-one correspondence with a plurality of teammate characters, and a binding identifier automatically following each of the teammate characters are displayed in an adjacent region of the “ball passing” button. Then, when the identifier update condition is met, for example, it is detected that a position at which a teammate character appears is inconsistent with a manipulation control, for example, a motion range of the teammate character changes, the display of the plurality of manipulation controls in one-to-one correspondence with the plurality of teammate characters, and the binding identifier automatically following each of the teammate characters may be automatically updated. This is not specifically limited in this embodiment of this disclosure.

In some other embodiments, the following processing may further be performed: applying, for a manipulation control corresponding to a second virtual object that meets a recommendation condition, a display manner (for example, the manipulation control corresponding to the second virtual object that meets the recommendation condition may be zoomed in or highlighted, to be recommended to the player) different from that of a manipulation control corresponding to a second virtual object that does not meet the recommendation condition, where the manipulation control corresponding to the second virtual object that meets the recommendation condition includes at least one of the following: a manipulation control corresponding to a second virtual object whose interaction frequency with the first virtual object is greater than a frequency threshold (for example, five times), a manipulation control corresponding to a second virtual object whose distance from the first virtual object is less than a distance threshold, and a manipulation control corresponding to a second virtual object that the first virtual object interacts with last time.

According to the interaction processing method for a virtual scene provided in the embodiments of this disclosure, the plurality of manipulation controls in one-to-one correspondence with the plurality of second virtual objects, and the binding identifier automatically following each of the second virtual objects are displayed in the adjacent region of the first control. In addition, a manipulation control and a binding identifier of a same second virtual object include same identification information, in other words, the plurality of manipulation controls are in one-to-one correspondence with the plurality of second virtual objects in the virtual scene. In this way, the player can select a manipulation control, to precisely select, from the plurality of second virtual objects, a target virtual object to be interacted with. This facilitates an operation by the player, and improves game experience of the player.

The following describes an example application of this embodiment of this disclosure in an actual application scenario by using a sports game (for example, a basketball game) as an example.

An embodiment of this disclosure provides an interaction processing method for a virtual scene. Virtual objects controlled in a game are switched by using a sliding operation by two fingers on a multi-touch-screen mobile terminal, for example, an operation such as switching a basketballer or designating a basketballer for ball passing involved in a sports game. In addition, a ball receiving object may be automatically recognized based on a current scene, and a player may perform the sliding operation to perform switching and ball passing. Compared with the solution provided in the related art, the solution provided in this embodiment of this disclosure is more intelligent and more convenient for the player to operate, to bring better game experience to the player.

The interaction processing method for a virtual scene provided in the embodiments of this disclosure is further described in detail below.

The solution provided in this embodiment of this disclosure can conveniently resolve the problem in the related art mentioned above, and can help a player to quickly find a corresponding basketballer to be switched and ball receiving object, and such an operation can also quickly find an orientation of the basketballer. This can improve game experience and fun of the player. Details are described below.

The interaction processing method for a virtual scene provided in the embodiments of this disclosure may be applied to a sports game, for example, applied to an operation of designating a ball receiving object or designating a switching object in the sports game.

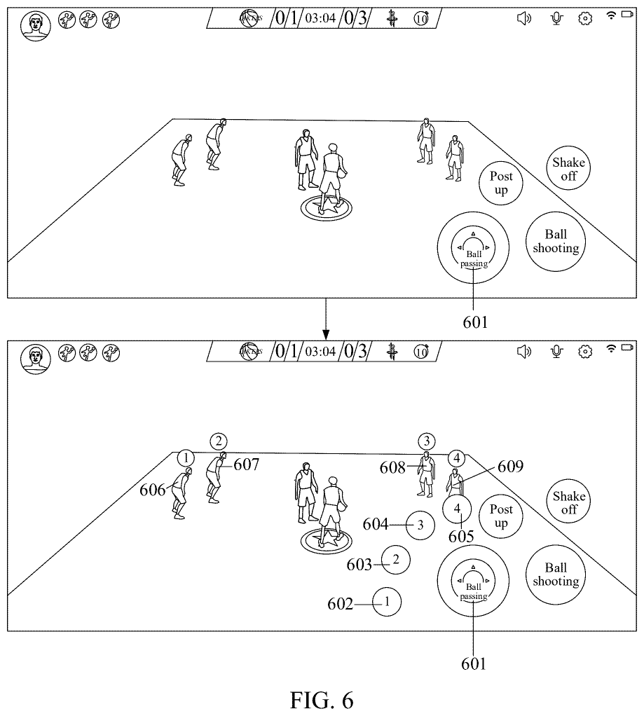

For example, referring to FIG. 6, FIG. 6 is a schematic diagram of an application scenario of an interaction processing method for a virtual scene according to an embodiment of this disclosure. As shown in FIG. 6, when a press operation performed by the player on a ball passing button 601 (corresponding to the foregoing first control) is received (that is, when the player presses and holds the ball passing button 601), the ball passing button 601 may change to a slidable state. When a sliding operation performed by the player on the ball passing button 601 is received, four buttons (corresponding to the foregoing manipulation controls, including a button 602, a button 603, a button 604, and a button 605, where the button 602 includes a number 1, the button 603 includes a number 2, the button 604 includes a number 3, and the button 605 includes a number 4) may appear for the player to make a selection. The four buttons correspond to positions of four basketballers (corresponding to the foregoing second virtual objects, including a basketballer 606, a basketballer 607, a basketballer 608, and a basketballer 609) on a court, and the four positions are arranged in an order from left to right of the court (that is, the leftmost basketballer 606 corresponds to the number 1, the second left basketballer 607 corresponds to the number 2, the second right basketballer 608 corresponds to the number 3, and the rightmost basketballer 609 corresponds to the number 4). In other words, a corresponding position of each player (or referred to as a teammate) on the court is consistent with a sliding position of the ball passing button 601. This helps the player to react first time, and conforms to a mental model of the player (that is, a fixed procedure and process in which the player thinks about a problem, where the model is affected by various factors such as the culture and qualities of the model).

The interaction processing method for a virtual scene provided in this embodiment of this disclosure mainly includes content in two aspects in terms of technical implementation. The first aspect is intelligent settings of numbers of basketballers on a court. For example, a left line of the court is used as a reference line, and logical determining is performed. A basketballer closest to the line is numbered 1 (corresponding to the foregoing binding identifier), displayed as a blue button 1. A basketballer second farthest to the line may be numbered 2, a basketballer third farthest to the line may be numbered 3, and a basketballer farthest to the line may be numbered 4. The basketballers may be numbered based on a call-out order. In addition, when the basketballers run and positions thereof are exchanged, the numbers corresponding to the current positions are not changed. Only when basketballers are called out again, the basketballers are renumbered based on latest positions of the basketballers. Therefore, the basketballer numbered 1 is always on the leftmost side of the court, and the corresponding button is a ball passing button at a leftmost position. This design is consistent with an operation by the player, and positions of the buttons are in one-to-one correspondence with positions of basketballers on the court. The remaining are the basketballers numbed 2, 3, and 4, and there are four buttons in total.

In the second aspect, positions of the buttons for calling are in one-to-one correspondence with the numbers of the basketballers. In other words, the position of the buttons 1, 2, 3, and 4 are fixed, and fixed muscle memory is generated each time the player performs an operation. This facilitates an operation by the player. In addition, these four positions are the same as the numbers of basketballers on the court, and therefore, this is more convenient and uniform in operation. In addition, when the player operates and selects the buttons 1, 2, 3, and 4, a selection region is zoomed in, and the selection is more intelligent. When the player slides the ball passing button, each time the player selects the ball passing button, the numbers 1, 2, 3, and 4 on the button are highlighted, to prompt that the button is selected, and a selected basketballer may also be highlighted, to prompt the player that the basketballer is selected.

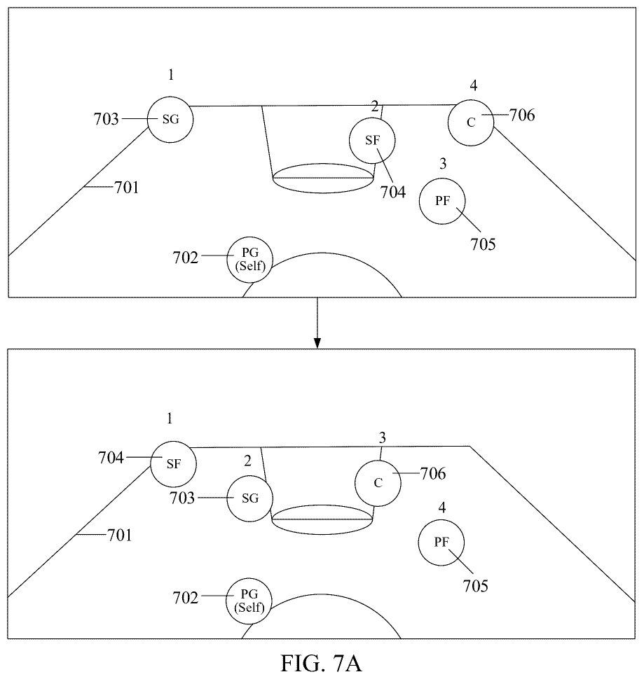

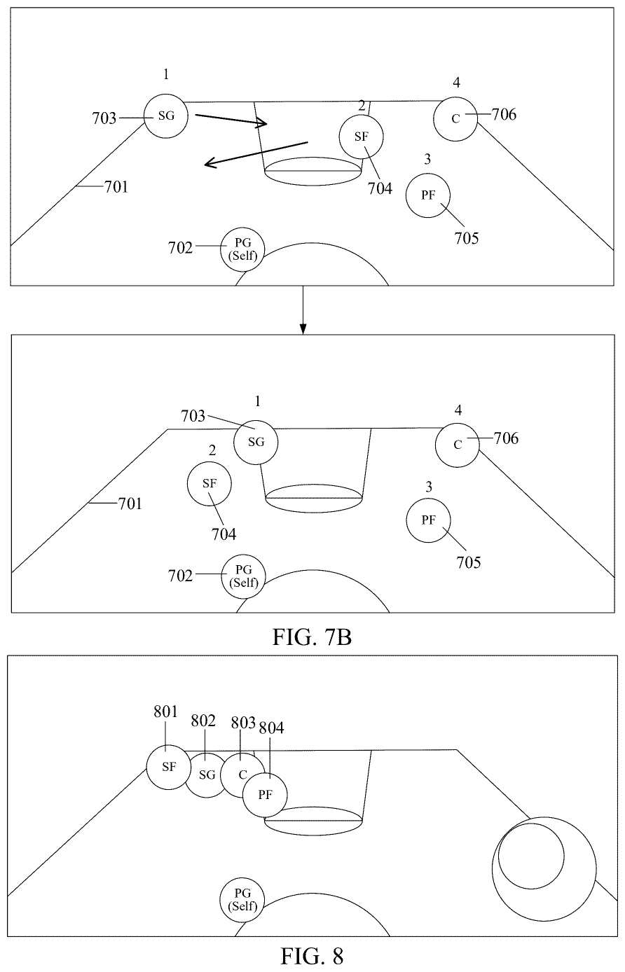

For example, referring to FIG. 7A, FIG. 7A is a schematic principle diagram of an interaction processing method for a virtual scene according to an embodiment of this disclosure. As shown in FIG. 7A, assuming that a basketballer currently controlled by the player is a point guard (PG) 702, a left line 701 of the court may be used as a reference line to number a plurality of basketballers on the court. For example, assuming that a shooting guard (SG) 703 is closest to the left line 701, the shooting guard 703 may be numbered 1; and assuming that a small forward (GF) 704 is a basketballer second closest to the left line 701, the small forward 704 may be numbered 2. By analogy, a power forward (PF) 705 third closest to the left line 701 may be numbered 3, and a center (C) farthest to the left line 701 is numbered 4. In addition, when the player releases the ball passing button and presses the ball passing button again, the player may renumber the plurality of basketballers based on latest positions of the plurality of basketballers on the court. For example, before running, the small forward 704 is closest to the left line 701, and the small forward 704 may be numbered 1; the shooting guard 703 is second closest to the left line 701, and the shooting guard 703 may be numbered 2; the center 706 is third closest to the left line 701, and the center 706 may be numbered 3; and a power forward 705 is farthest from the left line 701, and the power forward 705 may be numbered 4.

In some other embodiments, when the player presses and holds the ball passing button, a basketballer option may be called out. In this case, the basketballers have been numbered. When the basketballers run and relative positions are changed, numbers corresponding to the positions of the basketballers are not changed in this case. For example, assuming that the basketballer 1 runs to a middle position and is interchanged with the basketballer 2, as long as the player presses and holds the ball passing button without releasing the button, the numbers are not changed in this case until the player releases the pass button. When the player presses and holds the ball passing button again to call out the numbers of the basketballers, the numbers corresponding to the positions are changed, and this change is implemented according to the foregoing logic, that is, numbering is performed in an order closest to the left of the court.

For example, referring to FIG. 7B, FIG. 7B is a schematic principle diagram of an interaction processing method for a virtual scene according to an embodiment of this disclosure. As shown in FIG. 7B, assuming that a basketballer currently controlled by the player is a point guard 702, a left line 701 of the court may be used as a reference line to number a plurality of basketballers on the court. For example, assuming that a shooting guard 703 is closest to the left line 701, the shooting guard 703 may be numbered 1; and assuming that a small forward 704 is a basketballer second closest to the left line 701, the small forward 704 may be numbered 2. By analogy, a power forward 705 third closest to the left line 701 may be numbered 3, and a center farthest to the left line 701 is numbered 4. It is assumed that when the player presses the ball passing button, the shooting guard 703 and the small forward 704 run, for example, positions of the shooting guard 703 and the small forward 704 are changed. In this case, the numbers of the basketballers may be kept unchanged, for example, the shooting guard 703 is still numbered 1, and the score backstage 704 is still numbered 2.

In addition, compared with a game implementation mechanism provided in the related art, during selection of a designated basketballer in a game provided in the related art, because there is no one-to-one correspondence, and there is no logic of intelligently numbering selected object, a ball receiving object usually needs to be selected through observation. In addition, because there is no numbered button during selection, as shown in FIG. 8, when several players (including, for example, a small forward 801, a shooting guard 802, a center 803, and a power forward 804) are crowded together, it is very difficult for the player to quickly perform accurate selection, affecting game experience of the player. In other words, because there is no one-to-one correspondence in the solution provided in the related art, the game experience of the player is poor.

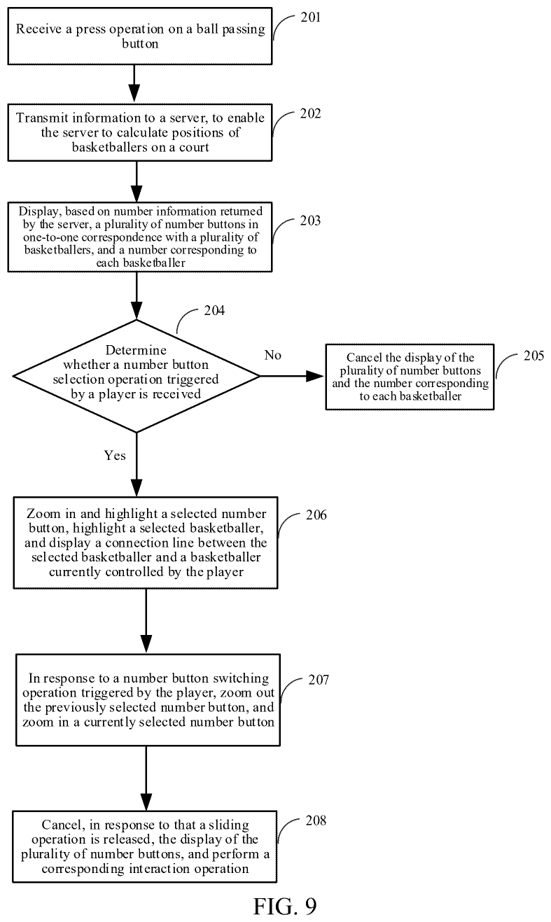

The interaction processing method for a virtual scene provided in the embodiments of this disclosure is further described in detail below with reference to FIG. 9.

For example, referring to FIG. 9, FIG. 9 is a schematic flowchart of an interaction processing method for a virtual scene according to an embodiment of this disclosure. Descriptions are given below with reference to operations shown in FIG. 9.

Operation 201: Receive a press operation on a ball passing button.

Operation 202: Transmit information to a server, to enable the server to calculate positions of basketballers on a court.

In some embodiments, when receiving the press operation by the player on the ball passing button, the client may send a corresponding press instruction to the server, so that the server can calculate the positions of the basketballers. For example, the server can analyze the positions of the basketballers on a court to determine a number corresponding to each basketballer. For example, a left line on the court is used as a reference line, and a basketballer closest to the left line is numbered 1.

Operation 203: Display, based on number information returned by the server, a plurality of number buttons in one-to-one correspondence with the plurality of basketballers, and the number corresponding to each basketballer.

The number button is the manipulation control described above. The number information is a binding identifier following a virtual object.

Operation 204: Determine whether a number button selection operation triggered by the player is received, and perform operation 205 if the number button selection operation is not received; or perform operation 206 if the number button selection operation is received.

Operation 205: Cancel the display of the plurality of number buttons and the number corresponding to each basketballer.

In some embodiments, the player does not select any number button when performing s sliding operation on the ball passing button (for example, a sliding track of the sliding operation does not pass any number button), the display of the plurality of number buttons and the number corresponding to each player may be canceled.

Operation 206: Zoom in and highlight a selected number button, highlight a selected basketballer, and display a connection line between the selected basketballer and a basketballer currently controlled by the player.

Operation 207: In response to a number button switching operation triggered by the player, zoom out the previously selected number button and zoom in a currently selected number button.

In some embodiments, assuming that the player selects a button 1 from the plurality of number buttons, the button 1 may be zoomed in and highlighted, to indicate that the button 1 is a number button currently selected by the player; and assuming that the sliding track passes the number 2 button as the player continues to slide, the button 1 may be zoomed out, highlighting of the button 1 is canceled, and then the button 2 may be zoomed in and highlighted, to indicate that the button 2 is a number button currently selected by the player, that is, the number button selected by the player is switched from the button 1 to the button 2.

Operation 208: Cancel, in response to that the sliding operation is released, the display of the plurality of number buttons, and perform a corresponding interaction operation.

In some embodiments, when it is detected that the sliding operation performed by the player is released, the display of the plurality of number buttons may be canceled, and the basketballer (for example, the point guard) currently controlled by the player is controlled to pass a ball to the selected basketballer (for example, the center), and the display of the connection line between the point guard and the center may also be canceled.

The technical solutions provided in the embodiments of this disclosure may be applied to a sports game and help a player to pass a ball or switch a control object by performing a quick, simple, and convenient operation. According to the solutions provided in the embodiments of this disclosure, positions of basketballers on a court can be automatically positioned, so that the player subconsciously select a basketball based on the positions of the basketballers on the court, and numbered positions of the basketballers can be easily selected when the basketballers are very crowded or in very narrow space. This is very easy to operate in such highly confrontational and intensive game experience, to further improve game experience and fun of the player.

The following further illustrates an exemplary structure in which the interaction processing apparatus 555 for a virtual scene provided in the embodiments of this disclosure is implemented as software modules. In some embodiments, as shown in FIG. 2, the software modules of the interaction processing apparatus 555 for a virtual scene stored in the memory 550 may include: a display module 5551 and a control module 5552.

The display module 5551 is configured to display a virtual scene in a human-computer interaction interface, the virtual scene including a first virtual object and a plurality of second virtual objects, and the first virtual object being a virtual object manipulated in the human-computer interaction interface. The display module 5551 is further configured to display, in an adjacent region of a first control, a plurality of manipulation controls in one-to-one correspondence with the plurality of second virtual objects, and a binding identifier automatically following each of the second virtual objects, a manipulation control and a binding identifier of a same second virtual object including same identification information. The control module 5552 is configured to control, in response to a manipulation control selection operation, the first virtual object to perform, on a target virtual object, an interaction operation associated with the first control, the target virtual object being a second virtual object corresponding to a selected manipulation control.

In some embodiments, the first control is associated with a prop passing function, and the first virtual object holds a virtual prop; and the control module 5552 is further configured to control the first virtual object to pass the virtual prop to the target virtual object.

In some embodiments, the first control is associated with a control switching function, and the first virtual object is automatically followed by a control identifier, where the control identifier indicates that the first virtual object is a currently manipulated virtual object in the human-computer interaction interface; and the control module 5552 is further configured to switch the control identifier from the first virtual object to the target virtual object, to enable the control identifier to automatically follow the target virtual object, to indicate that the target virtual object is a currently manipulated virtual object in the human-computer interaction interface.

In some embodiments, the manipulation control selection operation includes a sliding operation; the interaction processing apparatus 555 for a virtual scene further includes a determining module 5553, configured to determine, in response to the sliding operation, a manipulation control that a sliding track of the sliding operation passes as the selected manipulation control, and determine the second virtual object corresponding to the selected manipulation control as the target virtual object; and the control module 5552 is further configured to control the first virtual object to perform, on the target virtual object, the interaction operation associated with the first control.

In some embodiments, the first control is a triggered control in a plurality of candidate controls displayed in the human-computer interaction interface; the determining module 5553 is further configured to identify a triggered candidate control in the plurality of candidate controls as the first control in response to a control trigger operation; and the display module 5551 is further configured to display, in an adjacent region of a first control, a plurality of manipulation controls in one-to-one correspondence with the plurality of second virtual objects, and a binding identifier automatically following each of the second virtual objects.

In some embodiments, the plurality of candidate controls include the first control and at least one second control, where a type of the second control includes at least one of the following: a control associated with a prop throwing function and a control associated with a virtual object crossing function.

In some embodiments, the trigger operation includes a tap operation, and the manipulation control selection operation includes the sliding operation; the determining module 5553 is further configured to: in a case that the tap operation is not released, determine, in response to the sliding operation performed from a touch point of the tap operation, the manipulation control that the sliding track of the sliding operation passes as the selected manipulation control, and determine the second virtual object corresponding to the selected manipulation control as the target virtual object; and the control module 5552 is further configured to control the first virtual object to perform, on the target virtual object, the interaction operation associated with the first control.

In some embodiments, the display module 5551 is further configured to: in the adjacent region of the first control in response to that the sliding operation is released and the sliding track of the sliding operation does not pass any manipulation control, cancel the display of the plurality of manipulation controls in one-to-one correspondence with the plurality of second virtual objects, and cancel the display of the binding identifier automatically following each of the second virtual objects.

In some embodiments, the display module 5551 is further configured to refresh display of the selected manipulation control based on the manipulation control that the sliding track of the sliding operation currently passes; and the determining module 5553 is further configured to determine, in response to that the sliding operation is released, a selected manipulation control whose display is finally refreshed as a finally selected manipulation control.

In some embodiments, the interaction processing apparatus 555 for a virtual scene further includes an application module 5554, configured to apply, for the selected manipulation control, a display manner different from that of another manipulation control, and apply, for the target virtual object, a display manner different from that of another second virtual object.

In some embodiments, the display module 5551 is further configured to display the sliding track of the sliding operation in the human-computer interaction interface in real time.

In some embodiments, the display module 5551 is further configured to display, in the adjacent region of the first control in response to that a display condition is met, the plurality of manipulation controls in one-to-one correspondence with the plurality of second virtual objects, and the binding identifier automatically following each of the second virtual objects, where the display condition includes at least one of the following: an automatic display period reaches or the first virtual object enters a specific position in the virtual scene; and the display module 5551 is further configured to: in response to that a selection operation on the plurality of manipulation controls is not received within waiting time, cancel the display of the plurality of manipulation controls in one-to-one correspondence with the plurality of second virtual objects, and cancel the display of the binding identifier automatically following each of the second virtual objects.

In some embodiments, the manipulation control selection operation includes a tap operation; the determining module 5553 is further configured to use, in response to the tap operation, a tapped manipulation control as the selected manipulation control, and determine the second virtual object corresponding to the selected manipulation control as the target virtual object; and the control module 5552 is further configured to control the first virtual object to perform, on the target virtual object, the interaction operation associated with the first control.

In some embodiments, the display module 5551 is further configured to display, in the adjacent region of the first control in a specific sorting manner, the plurality of manipulation controls in one-to-one correspondence with the plurality of second virtual objects, where the sorting manner includes: an order in which current positions of the plurality of second virtual objects are arranged in a specific direction; an order in which preset locations of the plurality of second virtual objects in a camp to which the plurality of second virtual objects belong are arranged in a specific direction; an ascending order or a descending order of interaction frequencies between the plurality of second virtual objects and the first virtual object; an ascending order or a descending order of differences between moments at which the plurality of second virtual objects interact with the first virtual object last time and a current moment; and an ascending order or a descending order of distances between the plurality of second virtual objects and the first virtual object.

In some embodiments, after the plurality of manipulation controls in one-to-one correspondence with the plurality of second virtual objects, and the binding identifier automatically following each of the second virtual objects are displayed in the adjacent region of the first control, and before the manipulation control selection operation is responded to, the control module 5552 is further configured to control the plurality of manipulation controls in one-to-one correspondence with the plurality of second virtual objects, and the binding identifier automatically following each of the second virtual objects to remain unchanged.

In some embodiments, the display module 5551 is further configured to update, in response to an identifier editing operation, the display of the plurality of manipulation controls in one-to-one correspondence with the plurality of second virtual objects, and the binding identifier automatically following each of the second virtual objects; and update, in response to that an identifier update condition is met, the display of the plurality of manipulation controls in one-to-one correspondence with the plurality of second virtual objects, and the binding identifier automatically following each of the second virtual objects, where the identifier update condition includes that a motion range of any one of the second virtual objects changes.

In some embodiments, the application module 5554 is further configured to apply, for a manipulation control corresponding to a second virtual object that meets a recommendation condition, a display manner different from that of a manipulation control corresponding to a second virtual object that does not meet the recommendation condition, where the manipulation control corresponding to the second virtual object that meets the recommendation condition includes at least one of the following: a manipulation control corresponding to a second virtual object whose interaction frequency with the first virtual object is greater than a frequency threshold, a manipulation control corresponding to a second virtual object whose distance from the first virtual object is less than a distance threshold, and a manipulation control corresponding to a second virtual object that the first virtual object interacts with last time.

In some embodiments, when the control module 5552 controls the first virtual object to perform, on the target virtual object, the interaction operation associated with the first control, the display module 5551 is further configured to cancel the display of the plurality of manipulation controls in one-to-one correspondence with the plurality of second virtual objects, and cancel the display of the binding identifier automatically following each of the second virtual objects.

Descriptions of the foregoing apparatus embodiments are similar to the descriptions of the method embodiments. The apparatus embodiments have beneficial effects similar to those of the method embodiments and thus are not repeatedly described. Not mentioned technical details of the interaction processing apparatus for a virtual scene provided in this embodiment of this disclosure may be understood based on the descriptions in any one of FIG. 3, FIG. 5A, or FIG. 5B.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

An embodiment of this disclosure provides a computer program product. The computer program product includes a computer program or computer-executable instructions, the computer program or the computer-executable instructions are stored in a computer-readable storage medium. A processor of a computer device reads the computer-executable instructions from the computer-readable storage medium and executes the computer-executable instructions to cause the computer device to perform the foregoing interaction processing method for a virtual scene described in the embodiments of this disclosure.

An embodiment of this disclosure provides a computer-readable storage medium storing computer-executable instructions, the computer-executable instructions, when executed by a processor, causing the processor to perform the interaction processing method for a virtual scene provided in the embodiments of this disclosure, for example, the interaction processing method for a virtual scene shown in FIG. 3, FIG. 5A, or FIG. 5B.

In some embodiments, the computer-readable storage medium may be a memory such as a ferroelectric RAM (FRAM), a ROM, a programmable ROM (PROM), an electrically programmable ROM (EPROM), an electrically erasable PROM (EEPROM), a flash memory, a magnetic surface memory, an optical disk, or a CD-ROM, or may be any device including one of or any combination of the foregoing memories.

In some embodiments, the executable instructions can be written in a form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

The foregoing descriptions are merely embodiments of this disclosure and are not intended to limit the protection scope of this disclosure. Any modification, equivalent replacement, or improvement made without departing from the spirit and range of this disclosure shall fall within the protection scope of this disclosure.

What is claimed is:

1. An interaction processing method comprising:
displaying, in a game interaction interface, a virtual scene that includes a first virtual object and a plurality of second virtual objects;
displaying, based on selection of a first control element associated with an interaction operation, visual identifiers that each follow a respective second virtual object of the plurality of second virtual objects and, in a region adjacent to the first control element, a plurality of manipulation control elements that each indicate a respective visual identifier of the visual identifiers; and
controlling, based on a selection of a particular manipulation control element of the plurality of manipulation control elements, the first virtual object to perform the interaction operation with a target virtual object that corresponds to a particular second virtual object that is followed by the respective visual identifier indicated by the selected particular manipulation control element.

2. The method according to claim 1, wherein
the first control element is associated with a prop passing function, and the first virtual object holds a virtual prop; and
the controlling the first virtual object to perform the interaction operation includes controlling the first virtual object to pass the virtual prop to the target virtual object.

3. The method according to claim 1, wherein the first control element is associated with a control element switching function and the first virtual object is followed by a control element identifier that indicates that the first virtual object is a currently manipulated virtual object in the game interaction interface; and
the controlling the first virtual object to perform the interaction operation includes enabling the control element identifier to follow the target virtual object to indicate that the target virtual object is a currently manipulated virtual object in the game interaction interface based on switching the control element identifier from the first virtual object to the target virtual object.

4. The method according to any claim 1, wherein
the selection includes a sliding operation; and
the controlling the first virtual object to perform the interaction operation comprises:
determining, based on the sliding operation, a manipulation control element that a sliding track of the sliding operation passes as the particular manipulation control;
determining the second virtual object corresponding to the manipulation control element that the sliding track of the sliding operation passes as the target virtual object; and
controlling the first virtual object to perform the interaction operation.

5. The method according to any claim 4, wherein
the first control element is a triggered control element in a plurality of candidate control elements displayed in the game interaction interface; and
the displaying the plurality of manipulation control elements comprises:
identifying a triggered candidate control element in the plurality of candidate control elements as the first control element based on a control element trigger operation; and
displaying, in the region adjacent to the first control, the plurality of manipulation control elements.

6. The method according to claim 5, wherein
the plurality of candidate control elements include the first control element and at least one second control element, and
a type of the second control element includes at least one of a control element associated with a prop throwing function or a control element associated with a virtual object crossing function.

7. The method according to claim 5, wherein
the control element trigger operation includes a tap operation;
the selection operation includes the sliding operation; and
the controlling the first virtual object to perform the interaction operation comprises:
when the tap operation is not released, determining, based on the sliding operation performed from a touch point of the tap operation, the manipulation control element that the sliding track of the sliding operation passes as the particular manipulation control;
determining the second virtual object corresponding to the manipulation control element that the sliding track of the sliding operation passes as the target virtual object; and
controlling the first virtual object to perform the interaction operation.

8. The method according to claim 1, wherein
the selection includes a sliding operation; and
the controlling the first virtual object to perform the interaction operation comprises:
determining, when the sliding operation is released, that the sliding operation does not pass any manipulation control element of the plurality of manipulation control elements;
ceasing the displaying of the plurality of manipulation control elements; and
ceasing the displaying of the visual identifiers.

9. The method according to claim 4, wherein the determining the manipulation control element that the sliding track of the sliding operation passes as the particular manipulation control element comprises:
refreshing display of the particular manipulation control element based on the manipulation control element that the sliding track of the sliding operation currently passes; and
determining, based on that the sliding operation is released, the particular manipulation control element whose display is last refreshed as the particular manipulation control element.

10. The method according claim 1, comprising:
applying, to the particular manipulation control, a display manner different from that of another manipulation control element of the plurality of manipulation control elements, and applying, to the target virtual object, a display manner different from that of another second virtual object of the plurality of second virtual objects.

11. The method according to claim 4, comprising:
displaying the sliding track of the sliding operation in the game interaction interface in real time.

12. The method according to claim 1, wherein
the displaying the visual identifiers and the plurality of manipulation control elements includes displaying the visual identifiers and the plurality of manipulation control elements based on at least one of reaching an automatic display period or the first virtual object entering a specific position in the virtual scene; and
the method comprising:
based on that at least one of the selection is not received within a waiting time or the first virtual object entered the specific position in the virtual scene, ceasing the displaying of the plurality of manipulation control elements, and ceasing the displaying of the visual identifiers.

13. The method according to claim 1, wherein
the selection of the particular manipulation control includes a tap operation; and
the controlling the first virtual object to perform the interaction operation comprises:
using, based on the tap operation, a tapped manipulation control element as the particular manipulation control element;
determining the particular second virtual object corresponding to the particular manipulation control element as the target virtual object; and
controlling the first virtual object to perform the interaction operation.

14. The method according to claim 1, wherein the displaying the plurality of manipulation control elements comprises:
displaying, in the region in a sorting manner, the plurality of manipulation control elements, wherein the sorting manner includes at least one of:
an order in which current positions of the plurality of second virtual objects are arranged in a specific direction;
an order in which preset locations of the plurality of second virtual objects in a camp to which the plurality of second virtual objects belong are arranged in a specific direction;
an ascending order or a descending order of interaction frequencies between the plurality of second virtual objects and the first virtual object;
an ascending order or a descending order of differences between moments at which the plurality of second virtual objects last interacted with the first virtual object and a current moment; or
an ascending order or a descending order of distances between the plurality of second virtual objects and the first virtual object.

15. The method according to claim 1, comprising:
controlling the visual identifiers and the plurality of manipulation control elements to remain unchanged.

16. The method according to claim 1, comprising:
updating, based on an identifier editing operation, the display of the visual identifiers and the plurality of manipulation control elements; and
updating, based on an identifier update condition being met, the display of the visual identifiers and the plurality of manipulation control elements,
wherein the identifier update condition includes that a motion range of any one of the second virtual objects changes.

17. The method according to claim 1, comprising:
applying, for a recommended manipulation control element corresponding to a second virtual object that meets a recommendation condition, a display manner different from that of a manipulation control element corresponding to another second virtual object that does not meet the recommendation condition,
wherein the recommended manipulation control element comprises at least one of a manipulation control element corresponding to a second virtual object whose interaction frequency with the first virtual object is greater than a frequency threshold, a manipulation control element corresponding to a second virtual object whose distance from the first virtual object is less than a distance threshold, or a manipulation control element corresponding to a second virtual object that the first virtual object interacted with last.

18. The method according to claim 1, wherein the controlling the first virtual object to perform the interaction operation comprises:
ceasing the displaying of the plurality of manipulation control elements, and
ceasing the displaying of the visual identifiers.

19. An interaction processing apparatus comprising:
processing circuitry configured to:
display, in a game interaction interface, a virtual scene that includes a first virtual object and a plurality of second virtual objects;
display, based on selection of a first control element associated with an interaction operation, visual identifiers that each follow a respective second virtual object of the plurality of second virtual objects and, in a region adjacent to the first control element, a plurality of manipulation control elements that each indicate a respective visual identifier of the visual identifiers; and
control, based on a selection of a particular manipulation control element of the plurality of manipulation control elements, the first virtual object to perform the interaction operation with a target virtual object that corresponds to a particular second virtual object that is followed by the respective visual identifier indicated by the selected particular manipulation control element.

20. A non-transitory computer-readable storage medium, storing instructions which when executed by a processor cause the processor to perform:
displaying, in a game interaction interface, a virtual scene that includes a first virtual object and a plurality of second virtual objects;
displaying, based on selection of a first control element associated with an interaction operation, visual identifiers that each follow a respective second virtual object of the plurality of second virtual objects and, in a region adjacent to the first control element, a plurality of manipulation control elements that each indicate a respective visual identifier of the visual identifiers; and
controlling, based on a selection of a particular manipulation control element of the plurality of manipulation control elements, the first virtual object to perform the interaction operation with a target virtual object that corresponds to a particular second virtual object that is followed by the respective visual identifier indicated by the selected particular manipulation control element.
